(19) United States
(12) Patent Application Publication
(10) Pub. No.: US 2007/0199593 A1
(43) Pub. Date: Aug. 30, 2007

(54) Devices and methods for controlling fluid flow through conduits

(76) Inventors: Frank P. Mends, Maple Heights, OH (US); Ronald L. Dick, Boston Heights, OH (US); Stephen Moore, Cleveland, OH (US); Peter M. Oyster, Stow, OH (US); Kevin Mracek, Madison, OH (US); Douglas Winner, Chippewalake, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/703,930

(22) Filed: Feb. 8, 2007

Related U.S. Application Data
(60) Provisional application No. 60/772,446, filed on Feb. 10, 2006.

(51) Int. Cl. F17D 1/00

(52) U.S. Cl. 137/1

(57) ABSTRACT

A device for assembly to an end of a conduit is provided such that an internal surface of the conduit is not contacted by the device, through, for example, engagement of the device with an external surface of the conduit. Also, an assembly of one or more conduits and one or more devices is provided in which a test pressure may be measured near the conduit or conduits, which may allow for adjustment of fluid flow through the conduit or conduits to adjust the pressure in the conduit or conduits.

### CROSS REFERENCE TO RELATED APPLICATION

This application claims the benefit of U.S. Provisional Patent Application Ser. No. 60/772,446, entitled “Devices and Methods for Purging Conduits” and filed Feb. 10, 2006, the entire disclosure of which is hereby incorporated by reference.

### BACKGROUND OF THE DISCLOSURE

Conduits are welded together in a wide variety of applications. Most commonly conduits are welded together in the assembly of flow systems. Such a welded connection can perform one of many functions, such as extending or terminating an existing flow path, redirecting flow in a flow path, reducing or increasing the size of the cross-sectional area of a flow path, splitting or combining flow paths, or inserting components, such as, for example, a valve, into a flow path. Conduits may include, for example, pipe, tubing, and various flow components such as, for example, valves and fittings with end connections adapted for welding.

During the welding of metal components, it is customary to attempt to lessen or eliminate the presence of oxygen at or near the surfaces being welded. This process is often referred to as purging. Limiting or eliminating oxygen at these surfaces during welding can limit or eliminate oxidation at the site of the weld. One method of lessening or eliminating the presence of oxygen or other contaminants is to pass inert gases across the surfaces to be joined during the welding process. By exposing the weld site to the inert gas and consequently purging out the oxygen-bearing atmospheric air normally present in the conduit to be welded, potential oxidation in the weld joint can be minimized. To effectively purge atmospheric air from a conduit to be welded, the open ends of the conduit may be sealed, thereby limiting flow through the conduit to smaller ports used to supply a purge gas and expel atmospheric air. One example of a device for sealing the ends of a conduit for controlling the flow of purge gas through the conduit is included in U.S. Pat. No. 4,723,064, incorporated herein by reference in its entirety, which describes a circular plate and gasket adapted to attach to a pipe end by toggle joints positioned inside the pipe end.

### SUMMARY

The present application relates in part to the assembly of a flow control device to an end of a conduit such that an internal surface of the conduit is not contacted by the device, through, for example, engagement of the device with an external surface of the conduit. The flow control device may include any device capable of limiting, regulating, directing, or blocking flow through the conduit. For example, the device may include a purge fitting which may be adapted to seal the end of the conduit and provide a smaller port or aperture through which purge gas may be introduced into (or evacuated from) the inside of the conduit.

The present application also relates to measuring a test pressure within a conduit, for example, before or during a welding operation to facilitate adjustment or maintenance of a desired pressure within the conduit. In one embodiment, a device assembled with the conduit may be provided with a test port at which the internal pressure of the conduit may be measured. In another embodiment, the test port may be located at or near an intended weld site prior to a welding operation, which may allow for adjustment of a purge gas flow through the conduit or conduits to adjust the pressure in the conduit or conduits.

The present application also relates to supplying a fluid, such as a purge gas, into an open end of a conduit assembly having an opposite blocked end, such that fluid flow reaches a desired region of the conduit assembly, such as an intended weld site, before exiting from the open end of the conduit assembly. In one embodiment, a flow control device assembled with the open end of a conduit assembly includes an inlet aperture for introduction of fluid flow into the conduit assembly, and an outlet aperture for exhaust of fluid flow from the conduit assembly. A purge channel extends into the conduit assembly from one of the inlet and outlet apertures and seals with the corresponding aperture, such that fluid flowing through the conduit assembly flows at least to an inserted end of the purge channel.

While the exemplary embodiments herein are described and illustrated for use with conduits to be purged for welding, the inventive aspects described herein may be applied to any conduit arrangement, for example, arrangements in which assembly of a conduit with a flow control device is desired without engagement of an internal surface of the conduit, or in which fluid is to be supplied or regulated through one or more conduits.

According to an inventive aspect of the present application, a device is provided for controlling the flow of fluid to a conduit. In one embodiment, the device includes an end portion that at least partially covers an end of the conduit, with an aperture in the end portion to receive the purge gas. At least one side portion extends from the end portion and directs at least one connecting member to engage an external surface of the conduit to secure the device against the end of the conduit.

According to another inventive aspect of the present application, an assembly is provided for controlling the flow of fluid through first and second conduits. In one embodiment, an inlet flow control device is assembled to a distal end of the first conduit, with an inlet aperture for directing fluid into the first conduit. An outlet flow control device is assembled to a distal end of a second conduit, with an outlet aperture for directing fluid out of the second conduit. A test device is assembled between proximal ends of the first and second conduits, with the test device having an aperture for providing communication between internal cavities of the first and second conduits, and a test port extending from an external surface of the test device and being in communication with the cavities of the first and second conduits.

These and other aspects and advantages of the present invention will be readily appreciated and understood from the following detailed description of the invention in view of the accompanying drawings.

### BRIEF DESCRIPTION OF THE DRAWINGS

FIG. 1 is a schematic view of flow control devices assembled to conduits, shown with a partial cutaway view to illustrate internal features of the assembly;

FIG. 2 is a partial schematic side cross-sectional view of a flow control device assembled to a conduit;

FIG. 3 is a partial schematic side cross-sectional view of a flow control device assembled to two conduits; and

FIG. 4A is a perspective view of a purge fitting and conduit assembly;

FIG. 4B is a perspective view of the purge fittings of FIG. 4A;

FIG. 4C is a side cross sectional view of a purge fitting and conduit assembly; and

FIG. 5 is a side cross sectional view of a purge fitting with a purge port for purging of a blocked conduit.

### DETAILED DESCRIPTION

The present application relates to assembling a flow control device to an open end of the conduit, for example, to limit flow through the conduit to an aperture to which a source of fluid is connected, or to maintain a controlled pressure inside the conduit. In one such application, the flow control device regulates the flow of purge gas though a conduit to be welded. The purge gas may, for example, include one or more of many inert gases commonly used to purge atmospheric air from a weld site, such as argon or helium. Similarly, an opposite open end of the conduit or conduits to be welded may, but need not, be sealed by a flow control device to block flow or to limit flow out of the conduit or conduits to a smaller aperture. In one example, flow of purge gas through the conduit may be directed to the internal surfaces of the conduit, for example, through the use of a gas diffuser or similar device. Additionally, flow of purge gases through the conduit may be regulated, through the use of a restrictor such as a regulating valve, to control pressure in the conduits. Further, an embodiment of the present application provides for attachment of the flow control device to the conduit end in such a way that the internal surface of the conduit is not engaged by the flow control device or by any mechanisms used to affix the flow control device to the conduit end. In some applications, it may be desirable to maintain a smooth surface finish and minimal contamination to the internal surface of the conduit, conditions which may be affected by engagement with a flow control device or related components. Another exemplary embodiment provides a flow control device which can be used with conduits of differing size or diameter. Further, another inventive aspect of the invention provides for a measurement of pressure inside the conduit or conduits at or near the weld site before welding, which may allow the purge gas flow and conduit pressure to be appropriately adjusted prior to welding.

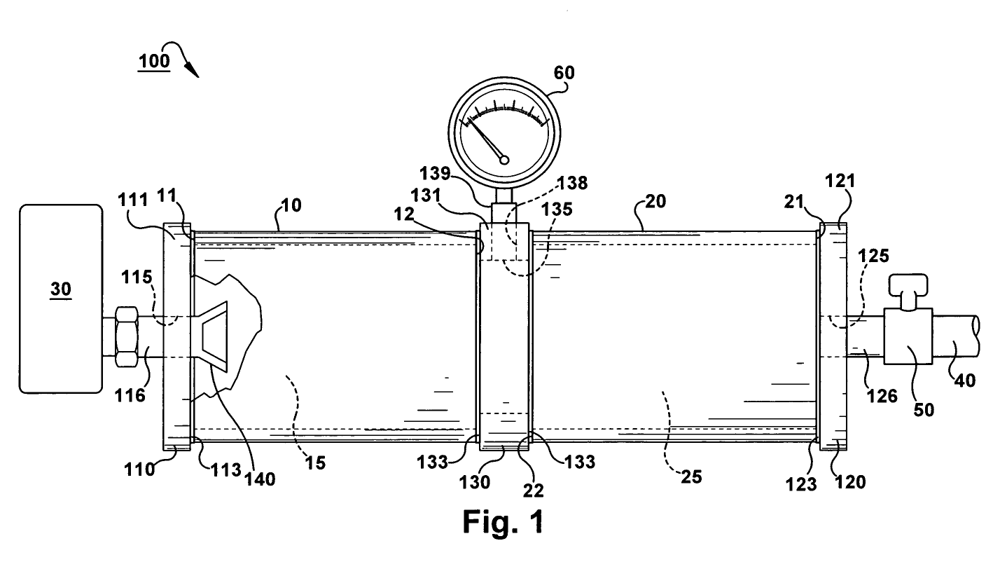

In one embodiment, shown schematically in FIG. 1, a purge assembly 100 for first and second conduits 10, 20 to be welded includes an inlet flow control device 110, an outlet flow control device 120, and a test device 130. The inlet flow control device 110 is assembled to a distal end 11 of first conduit 10 to seal the internal cavity 15 of the first conduit 10 from external atmosphere. Similarly, the outlet flow control device 120 of the exemplary embodiment is assembled to a distal end 21 of second conduit 20 to seal the internal cavity 25 of the second conduit 20 from external atmosphere. The test device 130 is assembled between a proximal end or weld end 12 of the first conduit 10 and a proximal end or weld end 22 of the second conduit 20 to seal the internal cavities 15, 25 of the first and second conduits 10, 20 from external atmosphere while keeping the internal cavity 15 of the first conduit 10 open to, or in communication with, or in fluid communication with, the internal cavity 25 of the second conduit 20. It should be noted, however, that an embodiment of the invention may incorporate the welding of more than two conduits in series, with the inlet and outlet flow control devices assembled to the distal ends of the outermost conduits, and with test devices, gaskets, or other seals initially assembled between the adjacent conduits to be welded. Further, an embodiment of the invention may include inlet and outlet flow control devices assembled to a single conduit, for purging the conduit for welding, for example, a fitting to an opening in the side of the conduit.

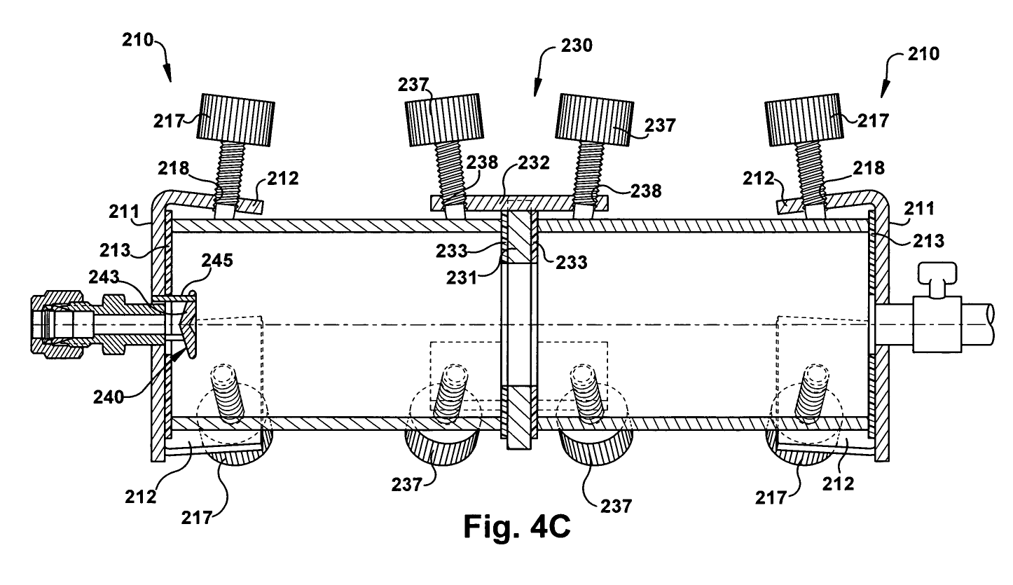

The exemplary test device 130 and flow control devices 110, 120 may include one of any number of fluid system components, including, for example, fittings, valves, filters, and regulators. In the exemplary embodiment of FIGS. 4A, 4B, and 4C, the test device and flow control devices are purge fittings with plate-like bodies, however, other types or shapes of fittings may be used.

The inlet flow control device 110 of the exemplary embodiment of FIG. 1 is provided with an inlet aperture 115 that passes through the inlet body 111. An inlet port 116 may be provided in communication with the inlet aperture 115 for connecting a fluid source 30 to the inlet aperture 115 to supply a fluid, such as, for example, a purge gas, to the first conduit 10. The inlet port 116 may be provided with one of many types of suitable connections, such as threaded pipe ends, compression tube fittings, and quick-disconnect couplings, for example, and may be welded to or threaded into the inlet fitting body 116, or any other suitable means of attaching the port to the fitting body 111. Additionally, the flow of purge gas into the conduit may be directed toward the surfaces of the conduit to be welded in order to more effectively remove contaminants from the portions of the conduit closest to the weld zone. For example, a gas diffuser 140 may be assembled to, or positioned proximate to, the inlet flow control device 110 inside the internal cavity 15 of the first conduit 10 to direct the purge gas towards the surface of the internal cavity 15.

A variety of gas diffusers may be used with the purge assembly. For example, a gas diffuser may include an obstructing member downstream of a flow source and positioned and adapted to direct a fluid flow outward, thereby diffusing the fluid over a larger area. One such example of an acceptable gas diffuser is illustrated in FIG. 4C. The example gas diffuser 240 includes a generally conical member 243 attached to the inlet body 211 by a plurality of mounting posts 245, such as dowel pins. The conical shape of the diffuser member 243 directs the incoming fluid flow outward toward the internal surfaces of the conduits. The tendency for a fluid stream to follow a curved surface (also known as the Coanda effect) causes the fluid, such as a purge gas, to flow along the internal surfaces of the conduits, thereby purging air and other contaminants more thoroughly from the surfaces near the intended weld site of the conduit or conduits. In another embodiment (not shown), a diffuser member may be contoured to cause the incoming fluid to swirl outward, which may effectively evacuate air and other contaminants from the conduit. While many materials may be used to construct the diffuser, including metals, ceramics, and plastics, a wear-resistant material capable of withstanding high temperatures, such as stainless steel, may be desired. Also, it should be noted that any suitable arrangement for positioning the diffusing member proximate to the inlet aperture while allowing flow into the conduit may be used, including, but not limited to, hooks, rigid wires, or a plug-type insert in the inlet aperture with openings allowing for outward flow (not shown).

While many different sealing arrangements may be provided between a flow control device and a conduit, in one embodiment, a seal member, such as, for example, an O-ring or a gasket, may provide a seal between the flow control device and an end face of the conduit. The inlet flow control device 110 of the exemplary embodiment may be provided with a gasket 113 or other such seal member positioned between the body 111 and the end of the conduit 10 to form a more effective seal between the flow control device 110 and the end face of the conduit 10. As the inlet flow control device 110 may remain assembled to the conduit 10 during a welding operation, the body 111 and gasket 113 are preferably constructed of materials that can withstand exposure to high temperatures. Additionally, the gasket 113 is preferably constructed of a closed-cell material, such as closed-cell silicone foam, that remains spongy, pliable and resilient during and after exposure to the elevated temperatures expected at the flow control device during the welding process.

The outlet flow control device 120 of the exemplary embodiment is provided with an outlet aperture 125 that passes through the outlet body 121. An outlet port 126 may be provided in communication with the outlet aperture 125 for connecting an exhaust line 40 to contain and direct purge gas and air expelled from the second conduit 20. The outlet port 126 may be provided with one of many types of suitable connections, such as threaded pipe ends, compression tube fittings, and quick-disconnect couplings, for example, and may be welded to or threaded into the outlet body 121, or any other suitable means of attaching the port. Additionally, a restrictor 50 may be connected to the outlet port 126 to regulate the flow of gases (both displaced air and purge gas) exiting the conduit 20, thereby regulating the pressure inside the conduits 10, 20. The restrictor 50 may, for example, include a regulating valve, such as a needle valve, which may be operated to increase or decrease the flow through the conduits 10, 20. It should be noted that a restrictor may additionally or alternatively be assembled to the inlet port 116 of the inlet flow control device 110, thereby regulating the flow of fluid into the conduits 10, 20.

The outlet flow control device 120 may also be provided with a gasket 123 or other suitable seal member positioned between the body 121 and the end face of the conduit 20 to form a more effective seal between the flow control device 120 and the conduit 20. As the outlet flow control device 120 may remain assembled to the conduit during a welding operation, the body 121 and gasket 123 are preferably constructed of materials that can withstand exposure to high temperatures. Additionally, the gasket 123 is preferably constructed of a closed-cell material, such as closed-cell silicone foam, that remains spongy, pliable and resilient during and after exposure to the elevated temperatures expected at the flow control device during the welding process.

The exemplary test device 130 is provided with a test aperture 135 that passes through the test device body 131. The test aperture 135 provides an opening between the internal cavity 15 of the first conduit 10 and the internal cavity 25 of the second conduit 20, so that the internal cavities 15, 25 are in communication with each other. Further, the exemplary test device 130 is provided with a test channel 138 that extends from an external surface of the test device 130 to a second surface of the test device body 131 in communication with the conduit cavities, such as the internal surface of the test aperture 135. The test channel 138 may be provided with a test port 139 for connecting to a pressure measurement device 60, which may provide a measurement of the internal pressure of the sealed conduits 10, 20. The test port 139 may be provided with one of many types of suitable connections, such as threaded pipe ends, compression tube fittings, and quick-disconnect couplings, for example, and may be welded to or threaded into the test device body 131, or any other suitable means of attaching the port. It should also be noted that a test port and test channel may alternatively or additionally be provided with the inlet flow control device and/or the outlet flow control device, such that the test channel extends from an external surface of the device to intersect the aperture, to provide for connecting to a pressure measurement device for measuring the internal pressure of the sealed conduits 10, 20.

The test device 130 may also be provided with gaskets 133 or other suitable seal members positioned between the body 131 and the end faces of the conduits 10, 20 to form a more effective seal between the test device 110 and the conduits 10, 20. Since the test device 130 is removed from between the conduits 10, 20 prior to welding, the thermal properties of the materials used to construct the test body 131 and gaskets 133 may not be important. As such, the test device 130 may be constructed of inexpensive and/or lightweight materials, such as plastic or aluminum. It may be preferable to construct the gaskets 133 in a material that is soft enough to create an adequate seal yet resistant to generation of particulate that would contaminate the conduits. An example of such a material is closed-cell silicone foam.

To adjust and test the internal conduit pressure of the exemplary conduit and purge assembly 100 of FIG. 1, the pressurized fluid source 30 is opened to allow purge gas to flow through the inlet port 116 and inlet aperture 115 into the internal cavities 15, 25 of the conduits, displacing the atmospheric air initially in the cavities 15, 25, which is allowed to flow out of the outlet aperture 125 and outlet port 126. A pressure measurement may be taken from the pressure measurement device 60 to determine the pressure at or near the intended weld site, between the first and second conduits 10, 20. To increase the conduit pressure, the restrictor 50 is incrementally closed, or operated to reduce flow through the restrictor 50 and through the conduits 10, 20. To reduce the conduit pressure, the restrictor is incrementally opened, or operated to increase flow through the restrictor 50 and through the conduits 10, 20. Once the restrictor 50 has been adjusted and set to achieve a desired flow rate and resulting internal conduit pressure, the test device 130 may be removed from between the conduits 10, 20, and the weld ends of the conduits 10, 20 may be butted against each other to perform the welding operation.

One of any number of weld fixtures may be used to hold the conduits together in alignment for welding by a suitable weld process such as, for example, orbital welding. An example of such a welding fixture for use in an orbital welding operation is disclosed in pending U.S. Pat. Application Publication No. 2006/0016857, for HIGH PRODUCTION WELD FIXTURE, which is incorporated herein by reference in its entirety.

Since leakage of purge gas from between the conduits 10, 20 is likely to occur during the welding operation, after the test device 130 and gaskets 133 have been removed and the conduits are butted against each other, the purge assembly 100 is likely to produce a lower internal pressure in the conduits 10, 20 during welding than what was measured prior to welding with the test device 130 installed between the conduits 10, 20. Therefore, it may be desirable to perform testing of the internal conduit pressure during purge testing (with the test device installed) compared to the corresponding internal conduit pressure during welding (with the test device removed and conduits butted together), to determine an adjustment factor. For example, using a constant pressure at the fluid source 30 and a constant setting or operating position of the restrictor 50, a pressure measurement is first taken with gaskets 133 assembled between the test device 130 and the conduits 10, 20, and a pressure measurement is subsequently taken with the test device 130 and/or gaskets 133 removed. The two pressure measurements may then be compared to each other to determine an adjustment factor. By applying the adjustment factor to the pressure measured at the test port during purge testing (with the test device 130 and gaskets 133 installed), the equivalent internal pressure during welding may be estimated, and the pressure while assembled to the test device 130 may be adjusted accordingly, through adjustment of the restrictor 50.

It should be noted that while the test device 130 is installed, prior to a welding operation, the type of gas used to test the pressure may be unimportant. As such, other gases, such as, for example, nitrogen or air, may be used while testing the purge assembly 100, with these gases being replaced with a more conventional purge gas, such as argon or helium, once the purge test is complete and the conduits are prepared for welding. However, it should also be noted that differing leak rates for different gases may be a factor to consider when using the measured test pressure to determine an equivalent welding pressure.

By adjusting the restrictor 50 and monitoring the pressure measurement device 60, the assembly may be set to provide a nominal internal pressure for the sealed conduits 10, 20 prior to initiating a welding operation. It is often desirable to maintain a nominal positive pressure inside the conduits 10, 20 during welding to provide a clean, flush, and fully penetrated weld along the entire weld seam. As such, by maintaining a predetermined internal pressure in the conduits, the quality of the weld may be enhanced.

According to another inventive aspect of the present application, a flow control device, such as, for example, the exemplary purge fittings described herein and illustrated in FIGS. 1-4C, may be configured to purge a conduit assembly having a blocked end or “dead end,” such as, for example, a capped conduit, or a conduit whose end is closed off by a valve or other device. Since the blocked conduit will not allow fluid flow past the blocked end, a flow control device having two apertures—one inlet aperture and one outlet aperture—may be used to provide fluid flow through the conduit assembly. The inlet aperture may comprise an opening in the flow control device through which the fluid flow is supplied, and may include an inlet port extending outward from the conduit assembly. The outlet aperture may comprise an opening in the flow control device through which the fluid flow is free to exit. In applications where flow of fluid into a portion of the blocked conduit assembly is desirable, such as, for example, in supplying purge gas to an intended weld site between an open conduit (to which the flow control device is assembled) and a blocked conduit, the flow control device may be configured to direct the flow of fluid introduced through the flow control device into the blocked conduit. In one such embodiment, a purge channel extends from one of the inlet and outlet apertures in the flow control device into the conduit assembly. While any extension of the purge channel into the conduit may assist in improved circulation of the introduced fluid, in one such embodiment, the channel extends at least to the location at which the introduced fluid is desired, such as, for example, an intended weld site, thereby promoting flow of the introduced fluid at least to desired location.

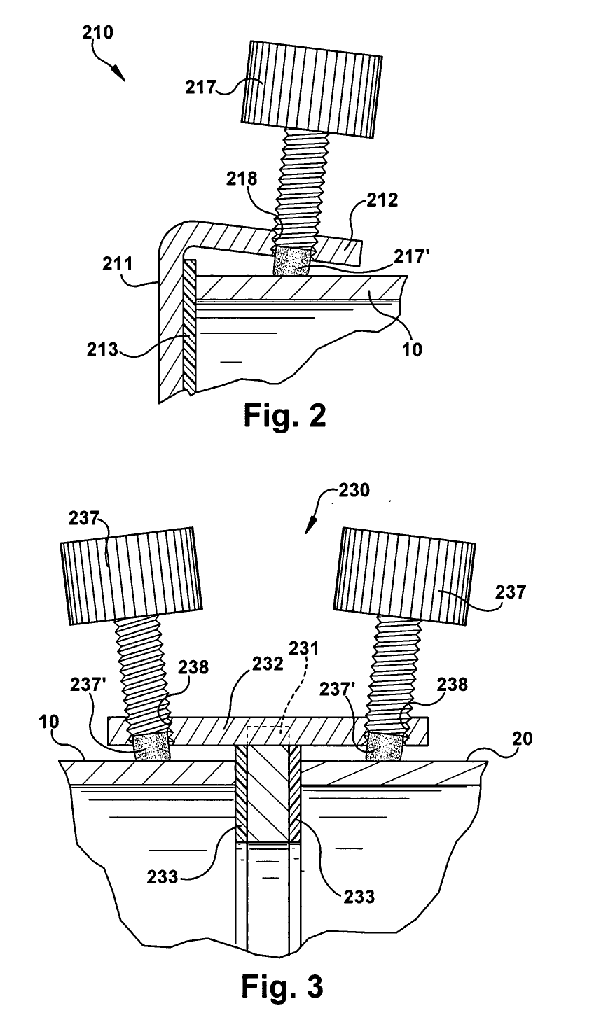

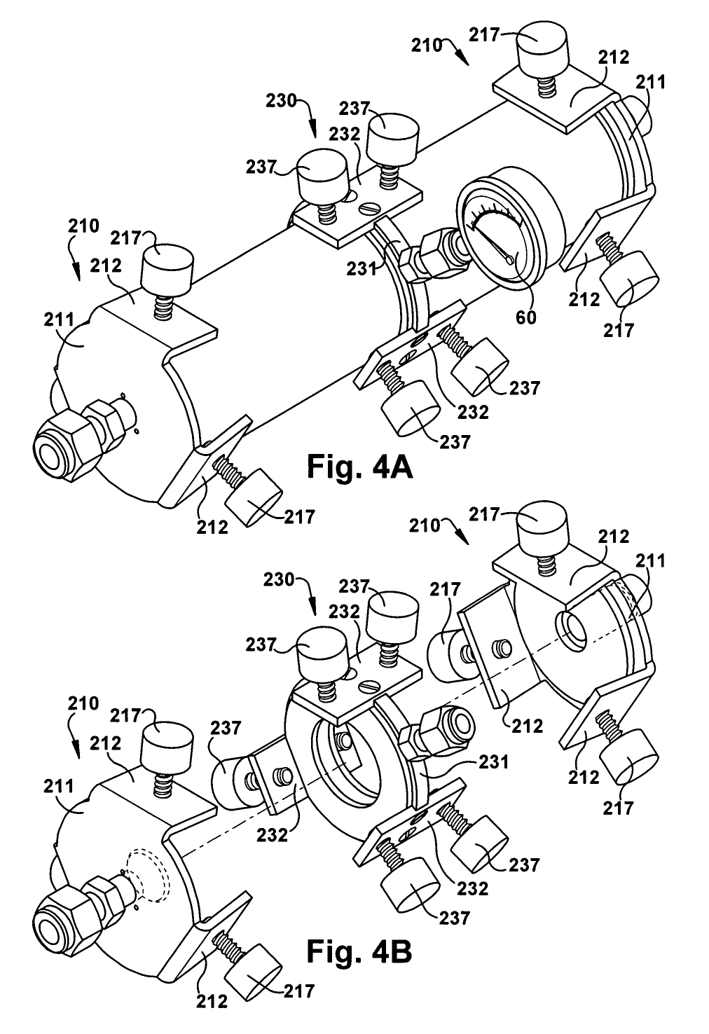

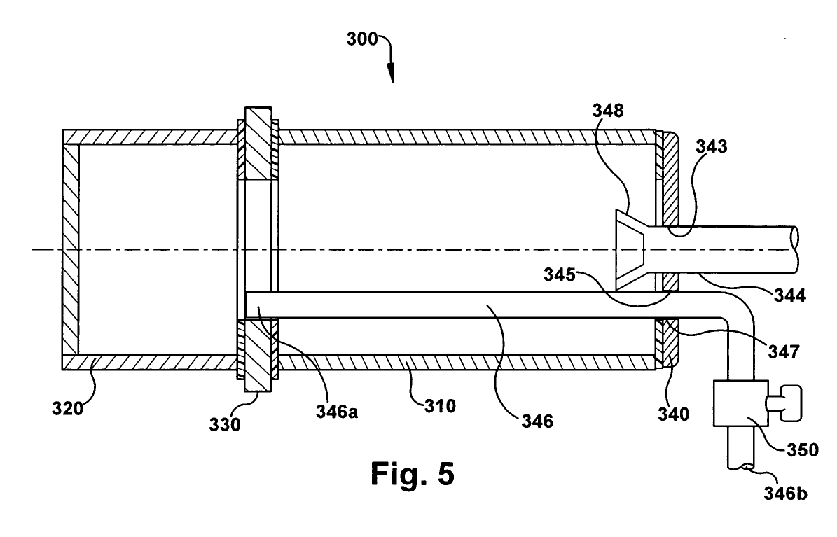

FIG. 5 schematically illustrates a conduit assembly 300 having a first open conduit 310 and a second blocked or capped conduit 320 joined by a fitting 330, which may, for example, be a test fitting, such as the test fitting 130 of FIG. 1. Alternatively the conduits 310, 320 may abut each other, for example, for welding the conduits 310, 320 together. A purge fitting 340 is assembled to the open conduit 310, and may, for example, be assembled using the clamping or fastening arrangement shown in FIGS. 2 and 3 and described below. The exemplary fitting 340 includes an inlet aperture 343 and an outlet aperture 345. An inlet port 344 may be provided in communication with the inlet aperture 343, for example, by welding or threaded assembly. A diffuser 348 may be assembled with the inlet aperture to direct fluid toward the internal surfaces of the conduit assembly 300. An outlet port or purge channel 346 is inserted through the outlet aperture 345. To limit the exhaust of introduced fluid to the purge channel 346, a seal may be provided between the outlet aperture 345 and the purge channel, such as, for example, a weld or a gasket type seal.

Any extension of the purge channel 346 into the conduit assembly 300 may assist in proving circulation of the introduced fluid within the conduit assembly, for example, by preventing fluid introduced through the inlet port 344 from immediately exiting through the outlet aperture 345. In one embodiment, to supply a fluid, such as, for example, a purge gas, to a desired region of the conduit assembly 300, such as, for example, the intended weld site (between the conduits 310, 320 upon removal of fitting 330 and abutment of the conduits 310, 320), a first end 346a of the purge channel 346 may be positioned to extend at least to the desired region, thereby forcing the introduced fluid to flow to the desired region before exiting through the purge channel 346. By providing an adjustable seal, such as a gasket 347, as opposed to a weld seal, the purge channel 346 may be adjusted to extend into the conduit assembly 300 by different lengths, to provide fluid flow at different locations in the conduit assembly, for example, to accommodate conduits 310 of varying lengths. A second end 346b of the purge channel 346, may, but need not, extend out of the conduit assembly 300, for example, to direct exhausted fluid into the environment or to connect with a container for reuse or safe retention of the fluid. While the purge channel 346 may alternatively be assembled with the inlet aperture 343 (not shown), the use of a diffuser 348 with the inlet aperture may limit use of the purge channel 346 to assembly with the outlet aperture 345. A restrictor 350, such as, for example, a regulating valve, may be assembled with the purge channel 346 to control the flow of fluid exiting the conduit assembly 300. Additionally or alternatively, a restrictor may be assembled with the inlet port 344 to control fluid flow through the conduit assembly.

Inlet and outlet flow control devices 110, 120 may take a wide variety of different forms. In one embodiment, the flow control device contacts or engages an outside surface of the conduit, but does not contact an inner surface of the conduit. In the example illustrated by FIG. 2, a flow control device 210, such as the inlet flow control device 110 or the outlet flow control device 120 of FIG. 1, may be assembled to a conduit 10 by sealing an end portion 211 of the flow control device 210 or plate against an end of the conduit 10 by one or more connecting members, such as, for example, fasteners 217, directed to engage an external surface of the conduit 10 and pull the end portion 211 and conduit end together into sealing engagement to at least partially cover the conduit end. The flow control device 210 may be provided with a side portion 212, which extends from the end portion 211 and is adapted to direct the fastener 217 radially toward the external surface of the conduit 10 and axially toward the end portion 211. In an exemplary embodiment, the end portion 211 may include a plate, and the side portion 212 may include a flange, which may include a hole 218 oriented to direct the fastener into engagement with the conduit 10. To provide for this angled orientation of the fastener 217, the flange 212 may be positioned to form an acute angle with the plate 211, as shown in FIG. 2, or the flange may be provided with a non-perpendicular hole to position the fastener 217 in the desired orientation (not shown), similar to the flange 232 of FIG. 3. When tightened against the conduit 10, the angled fastener 217 drives the conduit 10 toward the plate 211 and pulls the plate 211 against the end face of the conduit 10. Additionally, a gasket 213 or other suitable seal member may be provided between the plate 211 and the conduit 10 end face to form a more effective seal between the plate 211 and the conduit 10.

Further, while the flange 212 of FIG. 2 is an integral extension from the plate 211, the flow control device 210 may be provided with a flange that is separate from the plate and attached to the plate by any suitable means, such as by fasteners (not shown), similar to the flange 232 of FIG. 3. In one embodiment of the invention, as shown in FIG. 4B, the flow control device 210 utilizes three flanges 212 and three corresponding fasteners 217 spaced approximately evenly around the circumference of the plate 211 to provide a substantially uniform seal between the flow control device 210 and the conduit 10. However, a different number of flanges and fasteners may be used, and a different orientation or spacing of the flanges and fasteners around the plate may be provided. Also, a flow control device may be provided with flanges that accommodate more than one fastener per flange. Further, in one embodiment, the fasteners 217 are provided with tips 217′ constructed of a softer material, such as an elastomer, for example, rubber, to enhance the grip between the fastener and the conduit surface, and/or minimize marring of the external surface of the conduit 10. Additionally, it should be noted that the use of fasteners is just one example of how to connect a flow control device to a conduit end. The contemplated flow control devices and purge assemblies may utilize any suitable connection arrangement, including, for example, any connection arrangement that does not contact or engage the inside surface of the conduit. For example, a clamp, vice grip, magnetic, or suction-type seal (not shown) may be used.

Test devices can take a wide variety of different forms. For example, the test device may contact or engage outside surfaces of the conduits, without contacting inner surfaces of the conduits. In one embodiment, a device 230, such as the test device 130 of FIG. 1, may be assembled between two conduits 10, 20 by a side portion 232 extending from an end portion 231. In the example illustrated in FIG. 3, the end portion 231 is a plate, and the side portion 232 is a flange attached to an external surface of the plate 231. The flange 232 includes holes 238 oriented to direct the fasteners 237 radially toward external surfaces of the conduits 10, 20 and axially toward the plate 231. To provide for this angled orientation of the fasteners 237, the flange 232 may be provided with non-perpendicular holes 238 to position the fasteners 237 in the desired orientation. Alternatively, the flange may be bent so that the ends of the flange form acute angles with the plate 231 (not shown), similar to the flange 212 of FIG. 2. When tightened against the conduits 10, 20, the angled fasteners 237 drive the conduits 10, 20 toward the plate 231 and pull the plate 231 against the conduit 10. Additionally, gaskets 233 or other suitable seal members may be provided between the plate 231 and the conduits 10, 20 to provide more effective seals between the plate 231 and the conduits 10, 20.

Further, while the flange 232 of FIG. 3 is separate from the plate 231 and attached to the plate 231 by any suitable means, such as by fasteners, the device 230 may be provided with a flange 232 that is integral to and extends from the plate 231 at the desired angle, as shown in FIG. 2. In one embodiment of the invention, as shown in FIG. 4B, the device 230 utilizes three flanges 232 accommodating two fasteners 237 each (or six total fasteners) spaced approximately evenly around the circumference of the plate 231 to provide a substantially uniform seal between the device 230 and the conduits 10, 20. However, a different number of flanges and fasteners may be used, and a different orientation or spacing of the flanges and fasteners around the plate may be provided. Also, a device may be provided with flanges that accommodate only one fastener per flange, or three or more fasteners per flange. In one embodiment, the fasteners 237 are provided with tips 237′ constructed of a softer material, such as rubber, to enhance the grip between the fastener and the conduit surface, and/or minimize marring of the external surface of the conduits 10, 20. Additionally, it should be noted that the use of fasteners is just one exemplary means for connecting a test device between conduit ends. The contemplated test device and purge assemblies may utilize any suitable connection arrangement, including, for example, any connection arrangement that does not contact or engage the inside surface of the conduit. For example, a clamp, vice grip, magnetic, or suction-type seal (not shown) may be used.

The embodiments of FIGS. 2, 3, 4A, 4B, and 4C provide a device that engages with the external surface of the conduit without contacting the internal surfaces of the conduit, which may, for example, minimize damage and contamination of the internal surfaces of the conduit that may result from a plug-type purge fitting or any connection involving contact with the internal surfaces of the conduit. Further, the plate-type body and gasket seal offer a large area against which the conduit end may seal, thereby allowing use of the device with conduits of varying sizes.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

1. A device for controlling the flow of fluid to a conduit, the device comprising:
an end portion, adapted to at least partially cover an end of the conduit, the end portion comprising an aperture for receiving fluid flow;
at least one connecting member; and
a side portion, extending from the end portion, wherein the side portion is adapted to direct the at least one connecting member toward the end portion to engage an external surface of the conduit to secure the end portion against the end of the conduit when assembled with the conduit.

2. The device of claim 1, wherein the side portion is adapted to direct the at least one connecting member in a partially radial direction toward the conduit and in a partially axial direction toward the end portion when assembled with the conduit.

3. The device of claim 1, further comprising a seal member, adapted to form a seal between the end portion and the conduit end when assembled with the conduit.

4. The device of claim 1, further comprising an inlet port in communication with the aperture for directing fluid through the aperture and into the conduit when assembled with the conduit.

5. The device of claim 1, further comprising a gas diffuser in communication with the aperture for directing fluid towards an internal surface of the conduit when assembled with the conduit.

6. The device of claim 1, further comprising a restrictor in communication with the aperture for controlling a flow rate of fluid through the aperture.

7. The device of claim 6, wherein the restrictor comprises a regulating valve.

8. The device of claim 1, wherein the at least one connecting member comprises a fastener.

9. The device of claim 1, wherein the end portion further comprises a test channel extending from an outer surface of the end portion to a second surface of the end portion.

10. The device of claim 9, wherein the second surface of the end portion is defined by the aperture.

11. The device of claim 1, wherein the end portion comprises a plate.

12. The device of claim 1, wherein the side portion comprises a flange.

13. The device of claim 12, wherein the flange comprises a bracket connected to the end portion.

14. An assembly for controlling the flow of fluid through first and second conduits, the first and second conduits each comprising a proximal end face, a distal end face, and an internal cavity, the assembly comprising:
an inlet flow control device for assembly to the distal end face of the first conduit, wherein the inlet flow control device comprises an inlet aperture for directing fluid flow into the first conduit when assembled with the first conduit;
an outlet flow control device for assembly to the distal end face of the second conduit, wherein the outlet flow control device comprises an outlet aperture for directing fluid flow out of the second conduit when assembled with the second conduit; and
a test device for assembly between the proximal end face of the first conduit and the proximal end face of the second conduit, wherein the test device comprises a test aperture for providing communication between the cavities of the first and second conduits when assembled with the first and second conduits, and a test channel extending from an external surface of the test device, said test channel being in communication with the cavities of the first and second conduits when assembled with the first and second conduits;
wherein the test device seals with the proximal end faces of the first and second conduits when assembled with the first and second conduits.

15. The assembly of claim 14, wherein at least one of the inlet flow control device, the outlet flow control device, and the test device further comprises at least one connecting member and at least one flange, wherein, when assembled with a conduit, the at least one flange is adapted to direct the at least one connecting member toward an external surface of the conduit to secure the at least one of the inlet flow control device, the outlet flow control device, and the test device against the conduit.

16. The assembly of claim 14, wherein the inlet flow control device further comprises a gas diffuser proximate to the inlet aperture for directing fluid toward an internal surface of the conduit end when assembled with the first conduit.

17. The assembly of claim 14, wherein, when assembled with the first and second conduits, at least one of the inlet flow control device, the outlet flow control device, and the test device engages an external surface of one of the first and second conduits without contacting an internal surface of the first and second conduits.

18. A method for controlling the flow of purge gas to an open first conduit and a blocked second conduit to be welded to each other, the method comprising:
assembling a proximate end of the first conduit with the second conduit such that the first and second conduits are in fluid communication;
assembling a flow control device with a distal end of the first conduit, the flow control device having an inlet aperture and an outlet aperture;
directing a flow of purge gas through the inlet aperture of the flow control device into the first conduit;
extending a purge channel from an outlet port in the fitting into the first conduit, such that purge gas directed through the inlet port into the first conduit flows at least to an inserted end of the purge channel; and
allowing the flow of purge gas to exit the first and second conduits through the purge channel.

19. The method of claim 18, further comprising extending the inserted end of the purge channel at least to an intended weld site between the first and second conduits.

20. A flow control device for controlling the flow of fluid through a conduit assembly comprising an open first end and a blocked second end, and an internal cavity, wherein the distal end of the second conduit is blocked, the device comprising:
an inlet aperture for directing fluid flow into the first conduit when assembled with the first end of the conduit assembly;
an outlet aperture for directing fluid out of the conduit assembly when assembled with the first end of the conduit assembly; and
a purge channel extending from one of the inlet aperture and the outlet aperture into the conduit assembly when assembled with the first end of the conduit assembly, wherein the purge channel seals with the one of the inlet aperture and the outlet aperture, such that when the device is assembled with the conduit assembly, fluid introduced through the inlet aperture axially flows at least to an inserted end of the purge channel before exiting the conduit assembly through the outlet aperture.

21. The flow control device of claim 20, wherein the purge channel is movable with respect the outlet aperture, to adjust an axial position of the inserted end of the purge channel.
